(19) United States
(12) Patent Application Publication
(10) Pub. No.: US 2017/0007967 A1
(43) Pub. Date: Jan. 12, 2017

(54) MONOLITHIC SEPARATION MEMBRANE STRUCTURE

(71) Applicant: NGK INSULATORS, LTD., Nagoya-Shi (JP)

(72) Inventors: Makoto TERANISHI, Nagoya-Shi (JP); Hideyuki SUZUKI, Nagoya-Shi (JP); Ken KUWAMOTO, Nagoya-Shi (JP); Kenji MUTOH, Nagoya-Shi (JP); Masanori KATSU, Nagoya-Shi (JP)

(73) Assignee: NGK INSULATORS, LTD., Nagoya-Shi (JP)

(21) Appl. No.: 15/259,526

(22) Filed: Sep. 8, 2016

Related U.S. Application Data
(63) Continuation of application No. PCT/JP2015/056336, filed on Mar. 4, 2015.

(30) Foreign Application Priority Data
Mar. 31, 2014 (JP) 2014-072670

(51) Int. Cl. B01D 63/06; B01D 71/02; B01D 71/04; C04B 38/00; C02F 1/44; C04B 35/10; C04B 37/00; B01D 69/12; B01D 67/00

(52) U.S. Cl. CPC B01D 63/066; B01D 69/12; B01D 71/025; B01D 71/024; B01D 71/04; B01D 67/0046; C02F 1/44; C04B 35/10; C04B 37/001; C04B 38/00; B01D 2325/04; B01D 2325/02; C04B 2235/3217; C04B 2235/3232; C04B 2235/36; C04B 2237/343; C04B 2237/62

(57) ABSTRACT

A monolithic separation membrane structure (100) comprises a base material layer (211) and a first filtration layer (212). The first filtration layer (212) contains an aggregate material having a principal component of alumina and an inorganic binder having a principal component of titania. The thickness of the first filtration layer (212) is less than 150 micrometers.

### TECHNICAL FIELD

The present invention relates to a monolithic separation membrane structure.

### BACKGROUND ART

A monolithic separation membrane structure is known which includes a base material layer that has a plurality of through holes, and a tubular filtration layer formed on an inner surface of the through holes.

Patent Literature 1 discloses a method in which titania is added as a binder to an aggregate material for the purpose of enhancing the strength and chemical resistance of the filtration layer.

### CITATION LIST

### Patent Literature

### [Patent Literature 1] PCT Laid Open Application 2013/146956

### SUMMARY OF THE INVENTION

### Technical Problem

However, in addition to enhancement of the chemical resistance of the monolithic separation membrane structure, there is a need to also enhance the water flux (the permeability per unit surface area on the inner surface of the filtration layer) by enhancing permeability.

The present invention is proposed in light of the situation described above, and has the purpose of providing a monolithic separation membrane structure that enables enhancement of water flux.

### Solution to Problem

The monolithic separation membrane structure according to the present invention includes a base material layer and a tubular first filtration layer. The base material layer is composed of a porous material and includes a plurality of through holes. The first filtration layer is formed on an inner surface of the plurality of through holes. The first filtration layer contains an aggregate material having a principal component of alumina and an inorganic binder having a principal component of titania. The thickness of the first filtration layer is less than 150 micrometers.

### Effect of Invention

The present invention enables the provision of a monolithic separation membrane structure that enables enhancement of water flux.

### BRIEF DESCRIPTION OF THE DRAWINGS

FIG. 1 is a perspective view illustrating a monolithic separation membrane structure.

FIG. 2 illustrates a sectional view along the line A-A of FIG. 1.

FIG. 3 illustrates a sectional view along the line B-B of FIG. 2.

FIG. 4 illustrates a graph of the relationship of the thickness of the first filtration layer and water flux.

### DESCRIPTION OF EMBODIMENTS

Next, the embodiments of the present invention will be described making reference to the figures. In the description of the figures below, the same or similar portions are denoted by the same or similar reference numerals. However, the figures are merely illustrative and the ratio of respective dimensions or the like may differ from the actual dimensions. Therefore, the actual dimensions or the like should be determined by reference to the following description. Furthermore, it goes without saying that the ratios or the relations of dimensions used in respective figures may be different.

In the following embodiments, the term “monolithic” is a concept that denotes a shape that includes a plurality of through holes formed in a longitudinal direction, and includes a honeycomb shape.

### Structure of Monolithic Separation Membrane Structure 100

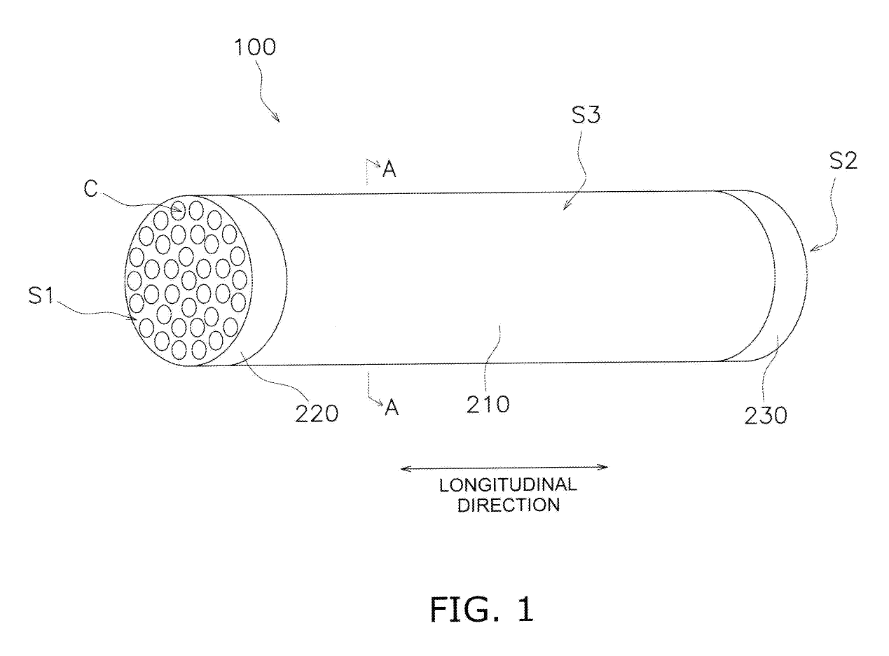

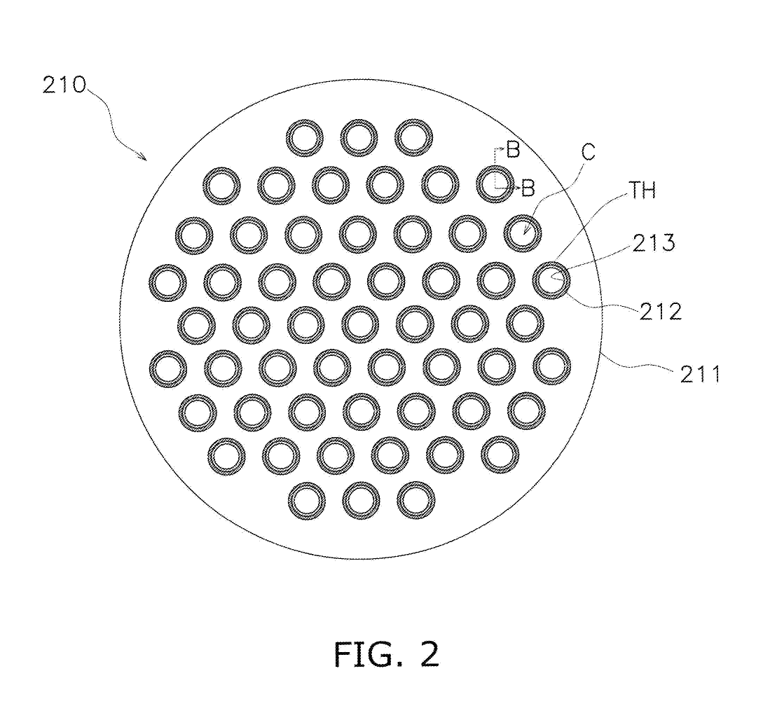

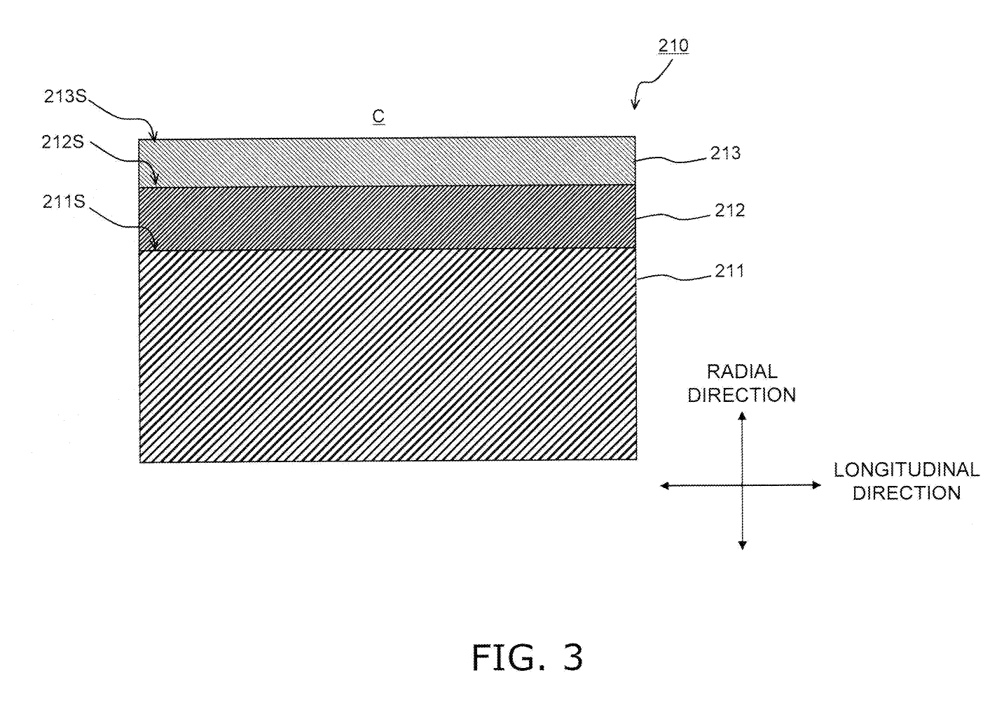

FIG. 1 is a perspective view illustrating a monolithic separation membrane structure 100. FIG. 2 illustrates a sectional view along the line A-A of FIG. 1. FIG. 3 illustrates a sectional view along the line B-B of FIG. 2.

The monolithic separation membrane structure 100 includes a base material body 210, a first seal portion 220 and a second seal portion 230. The monolithic separation membrane structure 100 exhibits chemical resistance to chemical washing or backwash, and can be used in water treatment processing.

The base material body 210 is formed as a circular cylinder. The length of the base material body 210 in a longitudinal direction is 150 to 2000 mm, and the diameter of the base material body 210 in the radial direction is 30 to 220 mm. However there is no limitation in this regard.

The base material body 210 has a first end surface S1, a second end surface S2 and a side surface S3. The first end surface S1 is provided opposite to the second end surface S2. The side surface S3 is connected to the outer edge of the first end surface S1 and the second end surface S2.

As illustrated in FIG. 2 and FIG. 3, the base material body 210 includes a base material layer 211, a first filtration layer 212 and a second filtration layer 213.

The base material layer 211 is formed as a circular cylinder. A plurality of through holes TH is formed in an inner portion of the base material layer 211. The through holes TH pass through the base material layer 211 from the first end surface S1 to the second end surface S2. The sectional shape of the through holes TH is circular. However there is no limitation in this regard. The inner diameter of the through holes TH may be configured as 1 to 5 mm.

The base material layer 211 is formed by a porous material. The porous material that configures the base material layer 211 includes use of a ceramic, metal, resin, or the like. In particular, use of a porous ceramic is preferred. The aggregate material used in relation to the porous ceramic material includes alumina (Al₂O₃), titania (TiO₂), mullite (Al₂O₃.SiO₂), potsherd, and cordierite (Mg₂Al₄Si₅O₁₈), and in particular, alumina is preferred in light of ease of availability, formation of a stable clay, and anticorrosive properties. The base material layer 211 may include an inorganic binder in addition to the porous material. The inorganic binder may include at least one of glass frits, titania, mullite, sinterable alumina, silica, clay minerals, and sinterable cordierite. In view of manufacturing costs, glass frits are particularly preferred.

The porosity of the base material layer 211 may be 25 to 50%. The average pore diameter of the base material layer 211 may be 5 micrometers to 25 micrometers. The average pore diameter of the base material layer 211 is the average value of the inner diameter of the pores formed in an inner portion of the base material layer 211. The average pore diameter of the base material layer 211 can be measured using a mercury press-in method. The average particle diameter of the porous material that configures the base material layer 211 may be 5 micrometers to 100 micrometers. In the present embodiment, the term “average particle diameter” denotes the value of the arithmetic mean for the maximum diameter of 30 measured particles that are measured by cross sectional micro-structure observation by use of a scanning electron microscope (SEM).

As illustrated in FIG. 3, the first filtration layer 212 is formed on the inner surface 211S of the through holes TH of the base material layer 211. The first filtration layer 212 has a tubular configuration. The first filtration layer 212 is formed from a porous ceramic material. More specifically, the first filtration layer 212 includes an aggregate material, and an inorganic binder. The aggregate material of the first filtration layer 212 includes alumina as a principal component. The inorganic binder of the first filtration layer 212 includes titania as a principal component. The titania particles in the inorganic binder form a thin film that covers at least a portion of the alumina particles in the aggregate material.

The thickness of the first filtration layer 212 in a direction perpendicular (hereafter referred to as the “radial direction”) to the central axis of the through holes TH can be less than 150 micrometers. The thickness of the first filtration layer 212 is preferably at least 10 micrometers. The thickness of the first filtration layer 212 is preferably no more than 70 micrometers. In the present embodiment, the term “thickness” of each layer denotes the average thickness value resulting from measurement at five positions in a longitudinal direction (including at least both end portions and the central portion).

The alumina concentration in the first filtration layer 212 is at least 60 wt % to no more than 95 wt %, and is preferably at least 80 wt % to no more than 95 wt %. The alumina concentration may be measured by EDS (energy dispersive X-ray analysis). The titania concentration in the first filtration layer 212 is at least 5 wt % to no more than 40 wt %, and is preferably at least 5 wt % to no more than 20 wt %. The titania concentration may be measured by EDS.

In the present embodiment, the disclosure that a composition X includes a substance Y “as a principal component” means that in relation to the total of the composition X, the substance Y preferably occupies at least 60 wt %.

The porosity of the first filtration layer 212 may be configured as 25% to 60%. The average pore diameter of the first filtration layer 212 may be configured to be smaller than the average pore diameter of the base material layer 211, and take a value of 0.005 micrometers to 5 micrometers. The average pore diameter of the first filtration layer 212 may be measured using an air flow method as prescribed by ASTM F316 (Standard Test Methods for Pore Size Characteristics of Membrane and Filters by Bubble Point and Mean Flow Pore Test).

The second filtration layer 213 is formed on the inner surface 212S of the first filtration layer 212. The second filtration layer 213 has a tubular configuration. The inner side of an inner surface 213S of the second filtration layer 213 includes the formation of a cell C configure to allow through flow of a mixed fluid (for example, potable water, or the like), that is the object of filtering. The inner diameter of the cell C in a radial direction is configured to be at least 0.5 mm to no more than 10 mm.

The second filtration layer 213 is composed of a porous ceramic material. The aggregate material of the porous ceramic material preferably includes titania as a principal component. When compared to other ceramic materials (for example, alumina, or the like), this configuration exhibits enhanced permeability and chemical resistance to acids and alkalis, in addition to enhanced production characteristics as a result of the capability of firing at a lower temperature. The second filtration layer 213 may contain an inorganic binder that can be used in the base material layer 211.

The thickness of the second filtration layer 213 in a radial direction can be configured to be at least one micrometer and no more than 50 micrometers. The thickness of the second filtration layer 213 is preferably at least 5 micrometers, and preferably no more than 20 micrometers. The porosity of the second filtration layer 213 may be configured as 25% to 50%. The average pore diameter of the second filtration layer 213 may be configured to a smaller value than the average pore diameter of the first filtration layer 212, of 0.005 micrometers to one micrometer. The average pore diameter of the second filtration layer 213 may be measured using an air flow method as prescribed by ASTM F316.

The first seal portion 220 covers the whole surface of the first end surface S1 and a portion of the side surface S3. The first seal portion 220 controls the direct infiltration, from the first end surface S2 to the base material body 210, of the mixed fluid to be filtered that enters the through holes TH. The first seal portion 220 is formed so that a barrier is not formed in relation to the input port for the cell C. The material that configures the first seal portion 220 includes use of glass, metal or the like. However, glass is preferred in light of adaptability with the thermal expansion coefficient of the base material body 210.

The second seal portion 230 covers the whole surface of the second end surface S2 and a portion of the side surface S3. The second seal portion 230 controls the direct infiltration, from the second end surface S2 to the base material body 210, of the mixed fluid that flows out of the through holes TH. The second seal portion 230 is formed so that a barrier is not formed in relation to the output port for the cell C. The second seal portion 230 may be composed of the same material as the first seal portion 220.

### Method of Manufacturing Monolithic Separation Membrane Structure 100

Firstly, a green body for the base material layer 211 that exhibits a plurality of through holes TH is formed by use of clay that includes a porous material. The porous material preferably contains an aggregate material having alumina as a principal component and an inorganic binder having glass frit as a principal component. The method of forming the green body for the base material layer 211 includes use of an extrusion molding method using a vacuum extrusion molding device, in addition to a press molding method or a slip cast method.

Next, the base material layer 211 is formed by firing (for example, 500 degrees C. to 1500 degrees C., 0.2 hours to 100 hours) the green body for the base material layer 211.

Then, a slurry for the first filtration layer is prepared by adding an aggregate material having alumina as a principal component, an inorganic binder having titania as a principal component, an organic binder, a pH adjusting agent and a surface active agent, or the like.

Next, the green body for the first filtration layer 212 is formed by a filtration method by use of the slurry for the first filtration layer. More specifically, a green body for the first filtration layer 212 is deposited on the inner surface 211S of the through holes TH by using a pump to draw the slurry for the first filtration layer from the inner surface S3 of the base material layer 211 while supplying the slurry to the through holes TH of the base material layer 211.

Then, the first filtration layer 212 is formed by firing (for example, 500 degrees C. to 1450 degrees C., 0.2 hours to 100 hours) the green body for the first filtration layer 212.

Next, a slurry for the second filtration layer is prepared by adding an aggregate material having titania as a principal component, an organic binder, a pH adjusting agent and a surface active agent, or the like.

The green body for the second filtration layer 213 is formed by a filtration method by use of the slurry for the second filtration layer. More specifically, a green body for the second filtration layer 213 is deposited on the inner surface 212S of the first filtration layer 212 by using a pump to draw the shiny for the second filtration layer from the inner surface S3 of the base material layer 211 while supplying the slurry to the inner side of the first filtration layer 212.

Then the second filtration layer 213 is formed by firing (for example, 500 degrees C. to 1450 degrees C., 0.2 hours to 100 hours) the green body for the second filtration layer 213.

### Characteristic Features

In the present embodiment, a monolithic separation membrane structure 100 includes the base material layer 211, and the first filtration layer 212. The first filtration layer 212 is composed of an aggregate material having a principal component of alumina and an inorganic binder having a principal component of titania. The thickness of the first filtration layer 212 is less than 150 micrometers.

In this context, since the average pore diameter of the first filtration layer 212 is less than the average pore diameter of the base material layer 211, when compared with the base material layer 211, the first filtration layer 212 tends to cause elution of the inorganic binder into a chemical during chemical washing or back washing. Therefore, in the present embodiment, the principal component of the inorganic binder of the first filtration layer 212 is configured as titania. Consequently, elution of the first filtration layer 212 can be suppressed in comparison with a configuration in which the inorganic binder contains a principal component of glass.

Since the thickness of the first filtration layer 212 is less than 150 micrometers, it is possible to effectively increase the permeability of the monolithic separation membrane structure 100 in comparison to a configuration in which the thickness of the first filtration layer 212 is at least 150 micrometers. As a result, a conspicuous enhancement to the water flux of the monolithic separation membrane structure 100 (the permeability per unit surface area on the inner surface 212S of the first filtration layer 212) is enabled.

### Other Embodiments

Although an embodiment of the present invention has been described, the present invention is not limited to the above embodiment, and various modifications are possible within a scope that does not depart from the spirit of the invention.
(A) In the above embodiment, the monolithic separation membrane structure 100 includes a first seal portion 220 and a second seal portion 230. However, at least one of the first seal portion 220 and the second seal portion 230 may be omitted.
(B) In the above embodiment, the base material body 210 includes the first filtration layer 212 and the second filtration layer 213. However, the second filtration layer 213 may be omitted.
(C) In the above embodiment, the base material body 210 includes the first filtration layer 212 and the second filtration layer 213. However, a further filtration layer may be provided between the base material layer 211 and the first filtration layer 212, or between the first filtration layer 212 and the second filtration layer 213. The further filtration layer may be configured using the same material as the first filtration layer 212 or the second filtration layer 213.
(D) In the above embodiment, the sectional shape of the cell C is circular. However a configuration as an oval or polygon is also possible.
(E) Although there is no particular disclosure of such a feature in the above embodiment, a separation membrane (for example, an NF membrane (nano-filtration membrane) or a UF membrane (ultrafiltration membrane, or the like) may be formed on an inner surface 213S of the second filtration layer 213. When the base material body 210 does not include a second filtration layer 213, this type of separation membrane may be formed on the inner surface 2125 of the first filtration layer 212.
(F) Although there is no particular disclosure of such a feature in the above embodiment, one or more further filtration layers may be formed on the inner surface of the second filtration layer 213. This type of filtration layer may be configured by use of the same porous ceramic material as the first filtration layer 212 or the second filtration layer 213. In this configuration, a separation membrane may be formed on the inner surface of the innermost filtration layer.

### EXAMPLES

The examples of the present invention will be described below. However, the present invention is not thereby limited to the following examples.

### Preparation of Samples No. 1 to No. 15

1. Samples 1 to 3

A monolithic separation membrane structure according to Samples No. 1 to No. 3 is prepared as described below.

Firstly, 20 parts by mass of glass fit was added to 100 parts by mass of alumina having an average particle diameter of 20 micrometers, then water, a dispersing agent and a thickener were added, and the mixture was kneaded to prepare a clay.

Next, a green body for the base material layer that includes a plurality of through holes was prepared by extrusion molding of the prepared clay.

The circular cylinder base material layer was prepared by firing the green body for the base material layer (1250 degrees C., 1 hour). The dimensions of the base material layer were a diameter of 30 mm and a length of 1000 mm.

Then, a slurry for the first filtration layer was prepared by adding an aggregate material of alumina, an inorganic binder of glass frit, an organic binder, a pH adjusting agent and a surface active agent, or the like. The composition ratio of the aggregate material and the inorganic binder was 10:1.

Next, a green body for the first filtration layer was deposited on the inner surface of the through holes by using a pump to draw the slurry for the first filtration layer from the inner surface of the base material layer while supplying the slurry to the through holes of the base material layer.

Next, the green body for the first filtration layer was fired (1250 degrees C., 1 hour). The thickness and the inner surface area of the first filtration layer are shown in Table 1.

Next, a slurry for the second filtration layer was prepared by adding titania as the aggregate material, an organic binder, a pH adjusting agent and a surface active agent. or the like.

Next, the green body for the second filtration layer was fired (950 degrees C., 3 hours).
2. Samples 4 and 5

Samples 4 and 5 were prepared using the same processing steps as Samples 1 to 3 with the exception that a firing temperature of 1250 degrees C. was used and the aggregate material for the second filtration layer is alumina.
3. Samples 6 to 11

Samples 6 to 11 were prepared using the same processing steps as Samples 1 to 3 with the exception that titania was used as the inorganic binder for the first filtration layer. It is noted that the dimensions of the base material layer in Sample No. 11 were a diameter of 180 mm and a length of 1500 mm.
4. Samples 12 to 15

Samples 12 to 15 were prepared using the same processing steps as Samples 1 to 3 with the exception that a second filtration layer was not prepared.

### Measurement of Permeability and Water Flux

Each sample was incorporated into a permeability device and water was sent through the samples to thereby measure the permeability and the permeation pressure. The permeation shown in Table 1 illustrates a velocity of water permeation at a pressure of 1 atm. The water flux is the permeability per unit area in the first filtration layer, and may be calculated by dividing the permeability by the surface area of the first filtration layer.

Measurement of Vickers Hardness after Chemical Processing

Test pieces removed respectively from Sample Nos. 1 to 3, and 7 to 10 were placed in a pressure vessel, and heated for three hours at 200 degrees C. while immersed in a chemical agent of sulfuric acid having a pH of 1.8. Thereafter the test pieces were removed and extensively washed. Then, the test pieces were placed in a pressure vessel and heated again for three hours at 200 degrees C. while the test pieces were immersed in an aqueous solution of 100 ppm hypochlorite. Chemical processing being a single cycle of two chemical loads resulting from application of the sulfuric acid and the hypochlorite was repeated until the Vickers hardness of the first support layer falls below 20. The cycle number for the chemical processing when the Vickers hardness had fallen below 20 is shown in Table 1.

The Vickers hardness was measured in accordance with the test method for Vickers hardness testing as stated in JIS Z 2244.

TABLE 1

| | | | | | | | | | | | Chemical | | |
|---|---|---|---|---|---|---|---|---|---|---|---|---|---|
| | | | | | | | | | | | processing | | |
| | Base material layer | | | First Filtration Layer | | | | | Second Filtration Layer | | cycle number | | |
| | | | Average | | | | Inner | Average | | Average | when Vickers | | |
| Sam- | | Inor- | Pore | | Inor- | Thick- | Surface | Pore | | Pore | hardness | Permea- | Water |
| ple | Aggre- | ganic | Radius | Aggre- | ganic | ness | Area | Radius | Aggre- | Radius | falls below 20 | tion | Flux |
| No. | gate | Binder | (μm) | gate | Binder | (μm) | (m²) | (μm) | gate | (μm) | (times) | (m³/d) | (m/d) |
| 1 | Alumina | Glass | 8 | Alumina | Glass | 140 | 0.41 | — | Titania | 0.1 | 8 | — | 45 |
| 2 | Alumina | Glass | 8 | Alumina | Glass | 110 | 0.43 | — | Titania | 0.1 | 8 | — | — |
| 3 | Alumina | Glass | 8 | Alumina | Glass | 70 | 0.44 | — | Titania | 0.1 | 8 | — | — |
| 4 | Alumina | Glass | 8 | Alumina | Titania | 140 | 0.41 | | Alumina | 0.1 | — | — | 22 |
| 5 | Alumina | Glass | 8 | Alumina | Titania | 250 | 0.38 | — | Alumina | 0.1 | — | — | 20 |
| 6 | Alumina | Glass | 8 | Alumina | Titania | 250 | 0.38 | — | Titania | 0.1 | — | 19 | 50 |
| 7 | Alumina | Glass | 8 | Alumina | Titania | 200 | 0.39 | — | Titania | 0.1 | at least 40 | 20 | 51 |
| 8 | Alumina | Glass | 8 | Alumina | Titania | 140 | 0.41 | — | Titania | 0.1 | at least 40 | 21 | 52 |
| 9 | Alumina | Glass | 8 | Alumina | Titania | 110 | 0.43 | — | Titania | 0.1 | at least 40 | 23 | 54 |
| 10 | Alumina | Glass | 8 | Alumina | Titania | 70 | 0.44 | — | Titania | 0.1 | at least 40 | 26 | 60 |
| 11 | Alumina | Glass | 8 | Alumina | Titania | 110 | 17 | | Titania | — | — | 1100 | 65 |
| 12 | Alumina | Glass | 8 | Alumina | Titania | 250 | 0.38 | 0.8 | None | — | — | 23 | 61 |
| 13 | Alumina | Glass | 8 | Alumina | Titania | 140 | 0.41 | 0.8 | None | — | — | 30 | 73 |
| 14 | Alumina | Glass | 8 | Alumina | Titania | 110 | 0.43 | 0.8 | None | — | — | 34 | 79 |
| 15 | Alumina | Glass | 8 | Alumina | Titania | 70 | 0.44 | 0.8 | None | — | — | 39 | 88 |

As shown in Table 1, Samples 7 to 10 that use titania as the inorganic binder for the first filtration layer exhibit a high cycle number for chemical processing until the Vickers hardness falls below 20. This result is due to the fact that the chemical resistance of the first filtration layer is enhanced by use of titania as the inorganic binder for the first filtration layer. Furthermore, the Vickers hardness of Samples 7 to 10 after 40 repetitions of the chemical processing was 25. In light of these results, similar chemical resistance can be obtained in relation to Sample Nos. 4 to 6, and 11 to 15 that use titania as the inorganic binder for the first filtration layer.

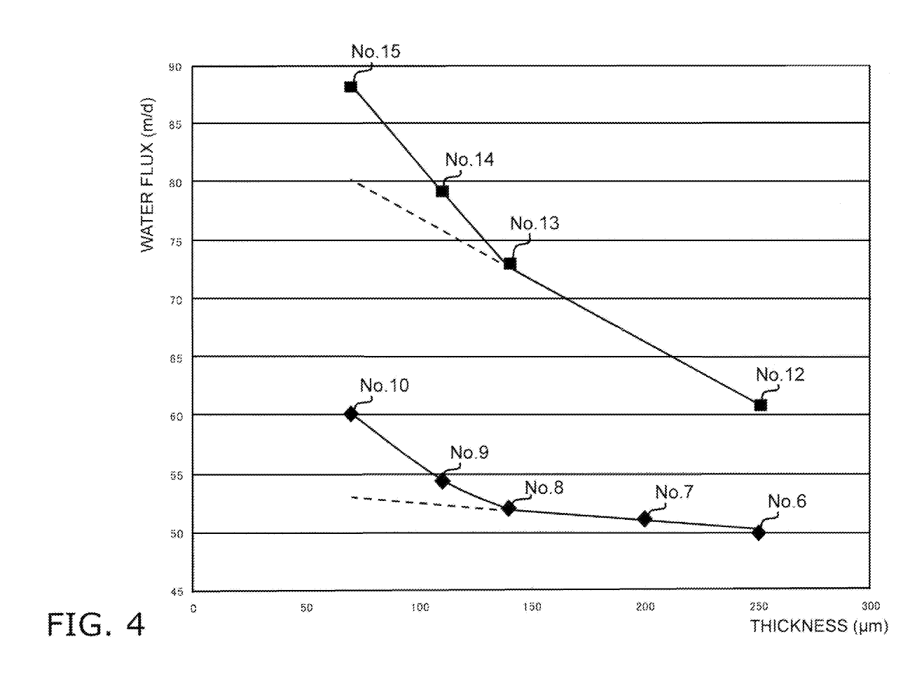

FIG. 4 illustrates a graph of the relationship of the thickness of the first filtration layer and water flux in relation to Sample Nos. 6 to 10 and 12 to 15. As illustrated in FIG. 4, when the thickness of the first filtration layer is at least 150 micrometers, water flux is enhanced in an inversely proportional manner to a reduction in the thickness. On the other hand, when the thickness of the first filtration layer is less than 150 micrometers, water flux is enhanced in as a geometrical series as the thickness is reduced. In this manner, the graph that illustrates the relationship of the thickness of the first filtration layer and water flux has an inflection point near to 150 micrometers, and therefore it can be confirmed that there is a conspicuous enhancement to water flux when the thickness is less than 150 micrometers.

As shown by a comparison of Sample No. 4 and Sample Nos. 8 to 10, it is confirmed that water flux is enhanced when titania is used in the second filtration layer in comparison to a configuration when alumina is used in the second filtration layer.

### DESCRIPTION OF THE REFERENCE NUMERALS

100 MONOLITHIC SEPARATION MEMBRANE STRUCTURE
210 BASE MATERIAL BODY
211 BASE MATERIAL
212 FIRST FILTRATION LAYER
213 SECOND FILTRATION LAYER
TH THROUGH HOLE
C CELL

1. A monolithic separation membrane structure comprising:
a base material layer composed of a porous material and including a plurality of through holes, and
a tubular first filtration layer formed on an inner surface of the plurality of through holes, wherein
the first filtration layer contains an aggregate material having a principal component of alumina and an inorganic binder having a principal component of titania, and
the thickness of the first filtration layer is less than 150 micrometers.

2. The monolithic separation membrane structure according to claim 1, further comprising:
a tubular second filtration layer formed on an inner surface of the first filtration layer, wherein
the second filtration layer contains an aggregate material having a principal component of titania.

3. The monolithic separation membrane structure according to claim 1, wherein
the base material layer contains an aggregate material having a principal component of alumina and an inorganic binder having a principal component of glass.

4. The monolithic separation membrane structure according to claim 3, wherein
an average pore diameter of the first filtration layer is smaller than an average pore diameter of the base material layer.

5. The monolithic separation membrane structure according to claim 2, wherein
the base material layer contains an aggregate material having a principal component of alumina and an inorganic binder having a principal component of glass.
